(19) United States
(12) Patent Application Publication
(10) Pub. No.: US 2025/0217816 A1
(43) Pub. Date: Jul. 3, 2025

(54) PRODUCT AUTHENTICATION USING PACKAGING

(71) Applicant: Sys-Tech Solutions, Inc., Princeton, NJ (US)

(72) Inventors: Bodhayan Dev, Sturbridge, MA (US); Hiren Patel, Monroe Township, NJ (US); Sreedhar Patnala, Holliston, MA (US); Prem Swaroop, Brookline, MA (US); Ajay Bhandari, Lexington, MA (US); Girish Juneja, Lexington, MA (US); Octavio Rodriguez Perez, Las Vegas, NV (US)

(21) Appl. No.: 18/400,874

(22) Filed: Dec. 29, 2023

(51) Int. Cl. G06Q 30/018; G06V 10/74; G06V 20/62; G06V 20/64

(52) U.S. Cl. CPC G06Q 30/0185; G06V 10/761; G06V 20/62; G06V 20/64

(57) ABSTRACT

A method includes capturing an image using a camera of a mobile device; processing the image using one or more machine learning models, wherein the one or more machine learning models have been trained to identify a face of first packaging in the image, and determine whether the first packaging in the image satisfies one or more capture conditions; providing feedback for image capture based on a first output of the one or more machine learning models relating to the one or more capture conditions; and in response to output of the one or more machine learning models indicating that the one or more capture conditions are satisfied, and in response to the output of the one or more machine learning models indicating that the face of the first packaging is present in the image, sending the image for authentication of the first packaging.

### FIELD OF THE DISCLOSURE

Technologies are described for authenticating products.

### BACKGROUND

Counterfeit products may be packaged in packaging that differs from the packaging used for authentic products despite an attempt to make the counterfeit packaging look authentic. Analysis of the packaging can thus indicate an authenticity of the product within.

### SUMMARY

Some aspects of this disclosure describe a method. The method includes capturing, at a mobile device, an image using a camera of the mobile device; processing, at the mobile device, the image using one or more machine learning models, wherein the one or more machine learning models have been trained to identify a face of first packaging in the image, and determine whether the first packaging in the image satisfies one or more capture conditions; providing, at the mobile device, feedback for image capture based on a first output of the one or more machine learning models relating to the one or more capture conditions; and in response to output of the one or more machine learning models indicating that the one or more capture conditions are satisfied, and in response to the output of the one or more machine learning models indicating that the face of the first packaging is present in the image, sending the image for authentication of the first packaging.

This and other methods described herein can have one or more of at least the following characteristics.

In some implementations, the one or more machine learning models have been trained to determine a face type of the face of the first packaging.

In some implementations, the face type includes a front face or a rear face.

In some implementations, the method includes determining whether the first packaging is authentic. Determining whether the first packaging is authentic includes: selecting, from two or more faces of second packaging, a first face based on the face type of the face of the first packaging matching a face type of the first face of the second packaging; determining at least one similarity between the first face and the face of the first packaging; and selecting, from among a plurality of images of packaging, an image of the second packaging as a reference image based on the at least one similarity between the first face and the face of the first packaging.

In some implementations, the at least one similarity includes a textual similarity between text included on the face of the first packaging and text included on the first face of the second packaging, and a graphical similarity between the reference image and the image.

In some implementations, determining whether the first packaging is authentic includes, in response to selecting the image of the second packaging as the reference image, determining whether the first packaging is authentic based on a comparison between the first packaging in the image and the second packaging in the reference image. In some implementations, the method includes determining whether the first packaging is authentic. Determining whether the first packaging is authentic includes: determining whether the image includes a data-encoding symbol; in response to determining that the image includes the data-encoding symbol, decoding data encoded by the data-encoding symbol, and determining a reference image based on the data, or in response to determining that the image does not include the data-encoding symbol, determining the reference image based on a graphical comparison between the image and the reference image.

In some implementations, the method includes determining whether the first packaging is authentic. Determining whether the first packaging is authentic includes: receiving the image from the mobile device, and processing the image using a machine learning model distinct from a first machine learning model, of the one or more machine learning models, that has been trained to identify the face of the first packaging in the image.

In some implementations, the method includes determining whether the first packaging is authentic. Determining whether the first packaging is authentic includes: determining a textual similarity between text in the image and text in a reference image; determining a graphical similarity between the image and the reference image; determining, based on at least one of the textual similarity or the graphical similarity, that the first packaging is not authentic; and determining, based on the image, a packaging of which the first packaging is a counterfeit.

In some implementations, the one or more capture conditions are based on at least one of an orientation of the first packaging in the image or a level of corruption in the image.

In some implementations, the feedback for image capture includes at least one of: a graphical bound for placement of the first packaging during image capture, the graphical bound being moved to different locations on a display of the mobile device over capture of multiple images, an indication of whether an orientation of the first packaging satisfies an orientation condition, or a progress indicator that progresses based on satisfaction of the one or more capture conditions.

In some implementations, the feedback for image capture includes an indicator of a location of corruption in the image.

In some implementations, the method includes training the one or more machine learning models. Training the one or more machine learning models includes: obtaining an image of reference packaging; generating a plurality of images by modifying at least one of orientation, background, or contrast of the image of the reference packaging; and training the one or more machine learning models using the plurality of images as training data.

In some implementations, the method includes determining whether the first packaging is authentic. Determining whether the first packaging is authentic includes: comparing at least one feature of the first packaging to a digital blueprint of reference packaging, the digital blueprint including a label indicating a face type of a face of the reference packaging, a graphical representation of the face of the reference packaging, and text included on the face of the reference packaging.

In some implementations, the method includes generating the digital blueprint. Generating the digital blueprint includes: processing an image of the reference packaging using a machine learning model that has been trained to determine the face type of the face of the reference packaging; and generating the digital blueprint based on an output of the machine learning model that has been trained to determine the face type of the face of the reference packaging.

In some implementations, the method includes training the one or more machine learning models using as training data, images of faces of a plurality of packaging, and as labels for the training data, data indicative of types of faces of the plurality of packaging portrayed in the images.

In some implementations, the one or more machine learning models include a first machine learning model that has been trained to identify the face of the first packaging in the image, and a second machine learning model that has been trained to determine whether the first packaging in the image satisfies the one or more capture conditions.

In some implementations, the method includes training the one or more machine learning models. Training the one or more machine learning models includes: providing, in a user interface, a display of an image of reference packaging captured by a second mobile device; processing the image of the reference packaging using a machine learning model that has been trained to identify a face of the reference packaging in the image of the reference packaging, to obtain, as an output, an auto-annotation indicative of at least one of text included in the face of the reference packaging, or a face type of the face of the reference packaging; providing, in the user interface, one or more tools usable to manually alter the auto-annotation to obtain a modified annotation; and training the one or more machine learning models using, as training data, the image of the reference packaging and the modified annotation.

The described methods can be associated at least with corresponding systems, processes, devices, and/or instructions stored on non-transitory computer-readable media. For example, some aspects of this disclosure describe a non-transitory computer-readable medium tangibly encoding a computer program operable to cause a data processing apparatus to perform operations of the foregoing method and/or other methods described herein. Further, some aspects of this disclosure describe a system including one or more computers programmed to authenticate images of packaging; and a mobile device communicatively coupled with the one or more computers, the mobile device being programmed to perform operations of the foregoing method and/or other methods described herein and to send the images of packaging to the one or more computers.

The details of one or more implementations are set forth in the accompanying drawings and the description below. Other aspects, features and advantages will be apparent from the description and drawings, and from the claims.

### BRIEF DESCRIPTION OF THE DRAWINGS

FIG. 1 is a diagram showing an example of image processing.

FIG. 2 is a diagram showing an example of a system associated with image processing.

FIG. 3 is a diagram showing an example of a packaging authentication process.

FIG. 4 is a diagram showing an example of a system associated with packaging authentication.

FIG. 5 is a diagram showing an example of an image processing and machine learning model training process.

FIG. 6 is a diagram showing an example of corruption-related processing.

FIGS. 7A-7B are examples of screen displays associated with image capture.

FIG. 8 is a diagram showing examples of screen displays associated with image capture.

FIGS. 9A-9C are examples of user interfaces associated with annotation.

FIG. 10 is a diagram showing examples of generated images.

### DETAILED DESCRIPTION

This disclosure relates to capturing and processing images of packaging for product authentication. For example, images of packaging can be processed using one or more machine learning models to facilitate capture of suitable images and to identify packaging in the images. A machine learning model trained to identify packaging can ensure that only images that include packaging undergo authentication testing, reducing computational errors and unnecessary bandwidth usage. In addition, a machine learning model trained to identify a face type (e.g., front packaging face or rear packaging face) can significantly reduce the search space for image comparison, leading to faster authentication and reducing usage of computational resources for authentication. Other machine learning models and processes described herein allow for the fast and efficient processing of images of packaging to create “digital blueprints” against which future images of packaging can be compared for authentication testing. Users can upload images of packaging, have the images auto-annotated using machine learning (in some cases with the option for manual annotation), and use the annotated images to train machine learning models without requiring technical, machine learning-specific tasks on the part of the users.

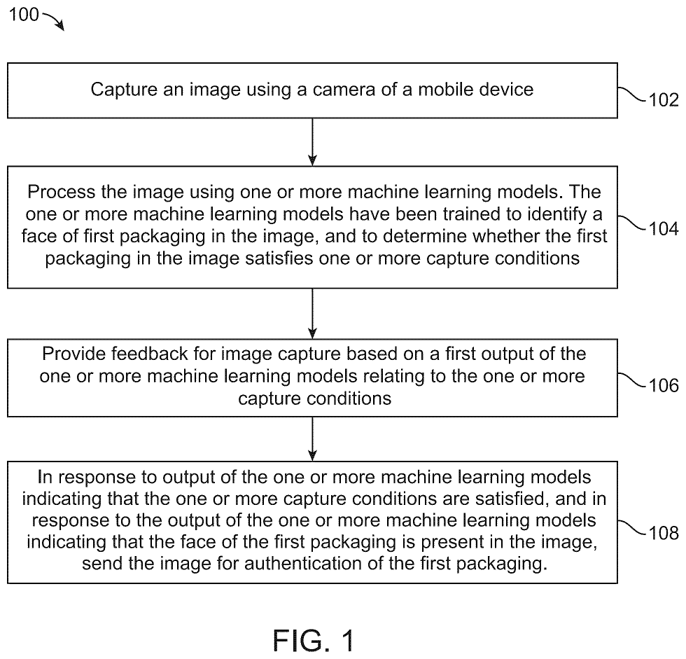

FIG. 1 shows an example of a process 100 according to some implementations of this disclosure. In some implementations, the process 100 can be performed by a mobile device, e.g., a smartphone, tablet, wearable device, laptop, or another type of mobile device. Performing the process 100 on a mobile device (e.g., a mobile device that captures images for processing) allows for real-time user feedback and correction, improving user experience. Moreover, as discussed in further detail below, the most computationally-intensive aspects of the processes discussed herein (e.g., reference image identification and/or image comparison) can be performed at a computer system remote from the mobile device (e.g., a cloud computing system), such that the mobile device can perform real-time tasks associated with image capture, while the remote computer system with more computational resources (e.g., storage and/or processing resources) can perform more computationally-intensive tasks, providing for overall efficient authentication. However, the process 100 need not be performed by a mobile device; elements of the process 100, and of other processes discussed herein, such as process 300 and process 500, can in various implementations be performed by a mobile device, by a remote computer system, or by the two in combination.

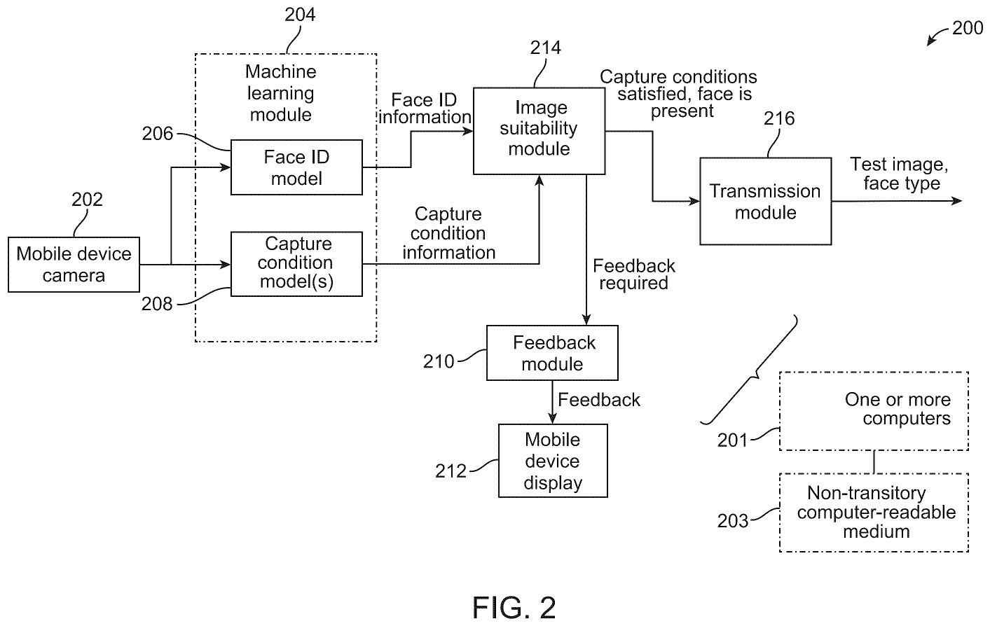

FIG. 2 shows an example of a system 200 associated with process 100. For example, elements of the system 200 can be configured to perform process 100. For example, the system 200 can include one or more computers 201 (e.g., a data processing apparatus) and a non-transitory computer-readable medium 203 tangibly encoding a computer program operable to cause the one or more computers 201 to perform process 100 and/or associated operations described herein. The one or more computers 201 and/or the non-transitory computer-readable medium 203 can implement at least some of the modules of FIG. 2.

The system 200 includes a mobile device camera 202, a machine learning module 204 implementing one or more machine learning model (in this example, a face identification model 206 and one or more capture condition models 208), an image suitability module 214, a feedback module 210, a transmission module 216, and a mobile device display 212. The mobile device camera 202 and the mobile device display 212 can be included in the same mobile device, e.g., a mobile device that also includes/implements the modules 204, 210, 214, 216.

The modules 204, 210, 214, 216 can be hardware and/or software modules, e.g., implemented by one or more computer systems. For example, the modules 204, 210, 214, 216 can include one or more hardware processors and one or more computer-readable mediums encoding instructions that, when executed by the one or more hardware processors, cause the one or more hardware processors to perform operations such as portions of process 100 and/or other processes described herein. The modules 204, 210, 214, 216 can be software modules executed by one or more hardware processors based on instructions encoded in one or more computer-readable mediums. In some implementations, the modules 204, 210, 214, 216 are modules of a mobile device, such that process 100 and associated operations can advantageously be performed largely or entirely on a mobile device, in some cases reducing processing latency compared to processes that require execution on a remote system. The modules 204, 210, 214, 216 need not be separate but, rather, can be at least partially integrated together as one or more combined modules or fully integrated together as a single program on the mobile device.

The process 100 includes capturing an image (sometimes referred to as a “test image”) using a camera of a mobile device (102), e.g., mobile device camera 202. For example, the test image can be an image of product packaging that a user would like to test to determine the authenticity of the product. For example, upon receiving a shipment of product, a merchant can capture an image of the product on their smartphone and quickly test the authenticity of the product. More specifically, processes described herein are used to test the authenticity of packaging, and, in many cases, it can be presumed that the authenticity of the product within the packaging follows the authenticity of the packaging. For example, some implementations according to this disclosure can be used to test the authenticity of medicine packaging, and counterfeit medicine may be presumed to be packaged in counterfeit packaging.

Capturing an image can include obtaining signals and/or data representative of the image (e.g., signals from photodetectors of the mobile device camera 202) and can include one or more processing steps performed on the image, such as downscaling/upscaling, size and/or resolution adjustment, computational distortion compensation, brightness adjustment (e.g., to compensate for underexposure/overexposure), and/or one or more other image adjustment operations.

The image can be captured as an individual image or in a sequence of images, e.g., in a sequence of images that form a video or live image. The capture of multiple images can allow a user to alter image capture in real-time (e.g., in response to feedback from the feedback module 210, as discussed in further detail below),

The process 100 further includes processing the test image using one or more machine learning models (104). The model(s) have been trained to (i) identify a face of first packaging in the test image, and ((ii) to determine whether the first packaging in the test image satisfies one or more capture conditions.

For example, in the system 200 of FIG. 2, a machine learning module 204 is configured to process the test image using a face identification model 206 and one or more capture condition models 208. The face identification model 206 is configured to identify a face of packaging in the test image, and the one or more capture condition models 208 are configured to determine whether capture conditions of the test image are satisfied. These processes are discussed in further detail below. However, the machine learning model(s) need not be divided in this manner. For example, in some implementations, a single machine learning model is configured to both identify a face of packaging (e.g., and/or perform other tasks described herein in relation to the face identification model 206) and to determine whether capture conditions are satisfied (e.g., and/or perform other tasks described herein in relation to the capture condition model(s) 208).

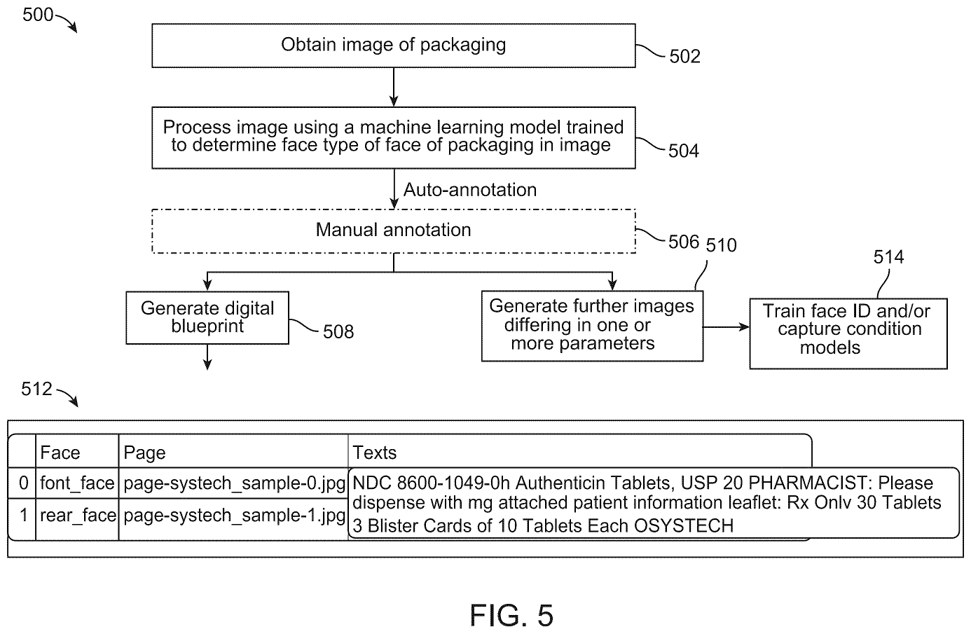

The face identification model 206 is configured to identify a face of packaging in the test image, e.g., to determine whether a packaging face is present in the image and, in some implementations, to determine location(s) of the face (e.g., a bounding box for the face). For example, the face identification model can be trained as discussed with respect to FIG. 5, or by another method. For example, the face identification model 206 can be trained using, as training data, (i) images that include faces of packaging (and, in some cases, images that do not include faces of packaging), and (ii) as labels of the images, an indicator of whether a packaging face is included and/or location(s) of the packaging face, in some cases with further label(s) such as a face type, as discussed in further detail below.

Face identification can serve as a prerequisite for further processing, to reduce wasted computational resources and user time. For example, it may be undesirable to perform a full authentication process on images without packaging, because such processing may (i) consume a significant amount of computational resources, and/or (ii) introduce error into datasets/machine learning models that are based on the images, e.g., because the datasets are intended to include only images with packaging or because the machine learning models are intended to be trained on images with packaging. Moreover, performing a “check” for a packaging face can allow a user to adjust image capture if no packaging face is detected, e.g., by adjusting focus settings or by bringing the mobile device camera 202 closer to the packaging. In some implementations, feedback provided to the user can include an indication of whether a packaging face was detected, as discussed in further detail below with respect to the feedback module 210.

The face identification model 206 can be an image classification model (e.g., to determine whether or not a packaging face is included in the test image) or an object detection model (e.g., to determine a location of the packaging face in the test image). In some implementations, the face identification model 206 is configured specifically for use on mobile devices, e.g., can be a TensorFlow Lite model.

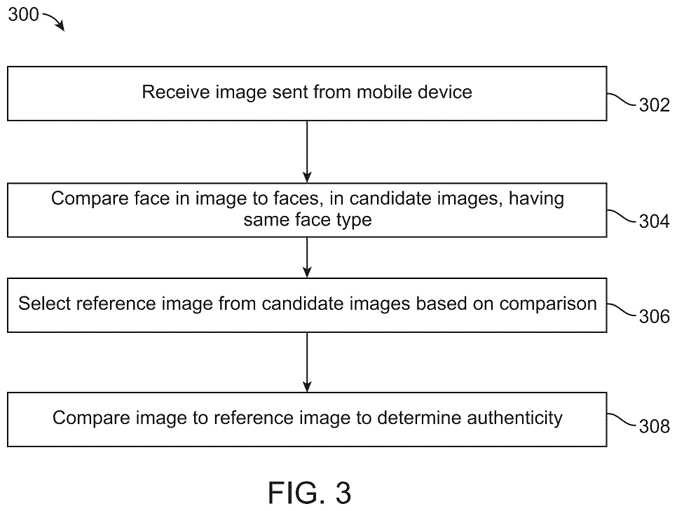

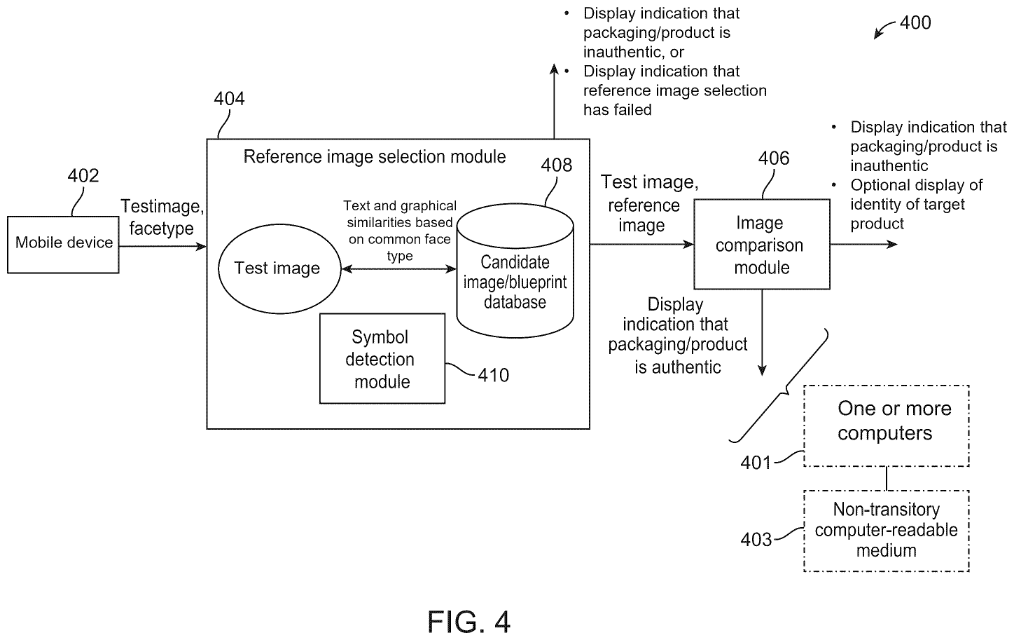

In some implementations, the face identification model 206 is configured to determine a face type of a packaging face in the test image. A “face type” can be, for example, a specific orientation of the face with respect to the packaging, for example, a front face, a rear face, or a side face. A “face” need not be flat (e.g., the packaging need not be cuboid) but, rather, can be curved. As discussed in further detail below with respect to FIGS. 3-4, the identification of a face type in the test image can reduce the search space for image-matching and facilitate faster, more computationally efficient authentication.

The capture condition model(s) 208 are configured to determine whether capture conditions are satisfied, and/or to provide information that can be used to make such a determination. For example, even in cases in which a packaging face is present (e.g., as determined by/using the face identification model 206), the test image may be unsuitable for authentication, such as because the packaging face is not sufficiently in-focus, because corruption (e.g., shadows/glare) is present in the image, and/or because the packaging face is not correctly oriented (e.g., tilted or inverted). Based on an output of the capture condition model(s) 208, corrective feedback can be provided to a user. Training of the capture condition model(s) 208 is discussed below with respect to FIG. 5.

Non-limiting examples of outputs of the capture condition model(s) 208 include: location(s) and/or level(s) of corruption (e.g., glare and/or shadow) in the test image; an orientation of a packaging face in the test image; a focus level of the packaging face in the test image; and/or a capture proportion of the packaging face in the test image (e.g., whether the entire face is imaged or whether a portion of the face is cut-off in the image frame). In some implementations, one or more different models are trained to provide one or more of these different outputs. In some implementations, a single model is trained to provide all outputs of the capture condition model(s) 208. Accordingly, hereafter the capture condition model(s) 208 are referred to as a capture condition model 208, with the understanding that two or more models can be trained as described and used to performed the described functions.

Referring again to FIG. 1, feedback for image capture is provided based on a first output of the one or more machine learning models relating to the one or more capture conditions (106). For example, the capture condition model 208 can output information relating to the capture conditions, and the feedback module 210 can generate and display (e.g., on the mobile device display 212) feedback based on the information relating to the capture conditions. In some implementations, providing feedback is conditional upon one or more of the capture conditions being unsatisfied, e.g., on a determination by the image suitability module 214 that feedback is required to improve image capture conditions. In some implementations, providing feedback can be performed even when image capture is satisfactory, e.g., to indicate that the capture is satisfactory and/or to provide a level of progress of image capture.

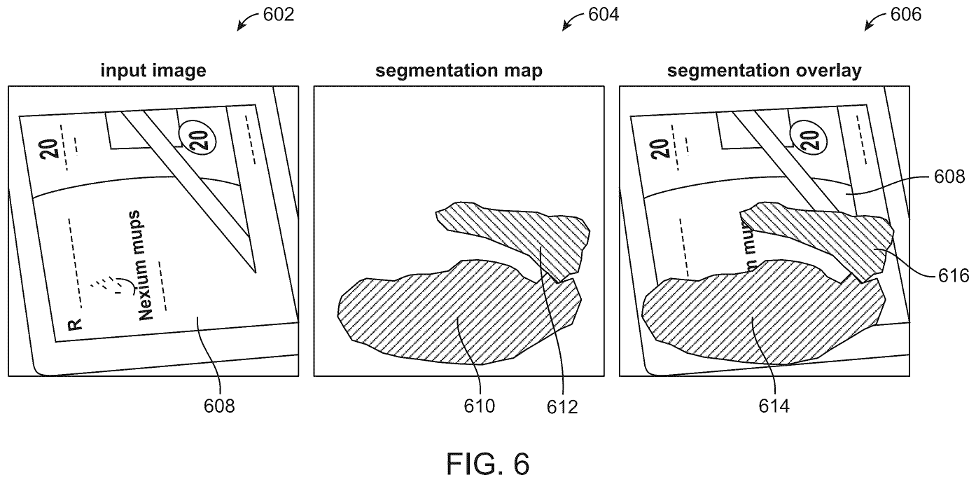

FIG. 6 illustrates an example of a captured test image 602; an image representing a corruption segmentation map 604 that can be output by some implementations of the capture condition model 208 or determined based on an output of the capture condition model 208; and an overlaid image 606 displayed by the feedback module 210 based on the corruption segmentation map. The test image 602 includes a packaging face 608. The segmentation map 604 identifies areas exhibiting one or more types of corruption in the test image 602. In this case, the segmentation map 604 identifies a diffused glare region 612 and a spot glare region 610. For example, the capture condition model 208 can be trained to identify (and output) types of corruption in images, and the regions exhibiting the corruption. The overlaid image 606 includes the packaging face 608 overlaid by overlays 616, 614 indicating the diffused glare region 612 and the spot glare region 610, respectively. For example, feedback including the overlaid image 606 can be displayed alongside a message instructing the user to adjust image capture to reduce the prominence of the glare, e.g., by changing an image capture angle and/or by changing lighting conditions. Although shown as opaque in FIG. 6, in some implementations an overlay can be partially transparent to show the full test image underneath the overlay. For example, different-colored transparent overlays can be used to illustrate different types of corruption (e.g., spot glare, diffused glare, and/or shadow). In some implementations, the colors can match feedback provided by the feedback module 210. For example, the feedback can instruct a user to “decrease glare in red region,” and a red overlay can be displayed over a region exhibiting glare.

In some implementations, the capture condition model 208 is trained to output a proportion of the test image and/or of the packaging face in the test image that is obscured by corruption. This proportion can be compared to a threshold proportion, e.g., as discussed below in reference to the image suitability module 214.

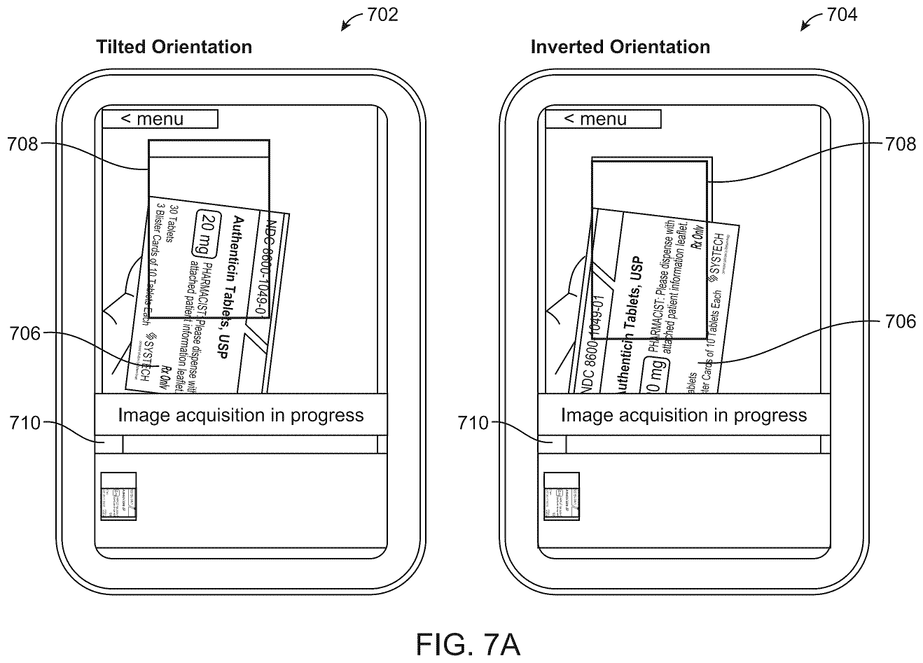

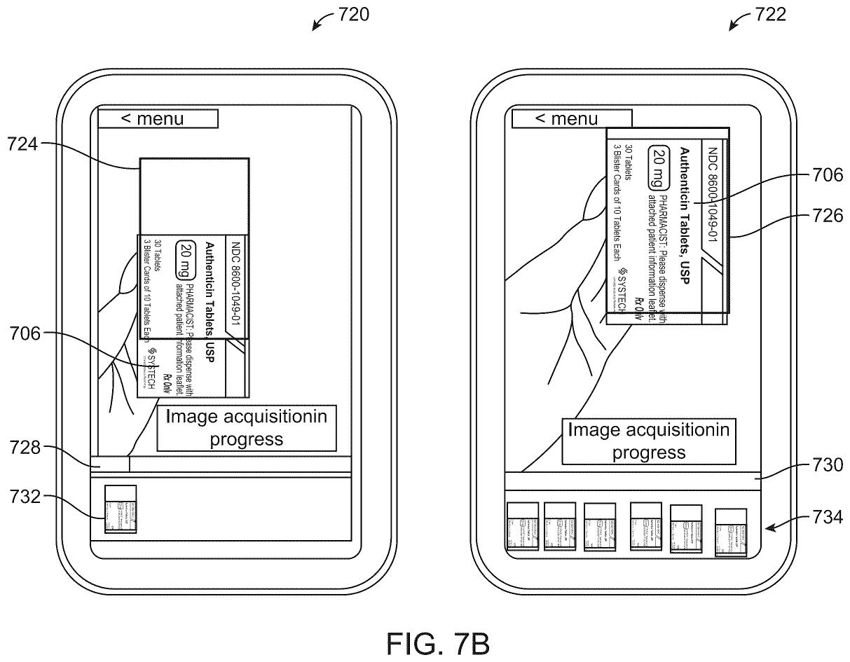

FIG. 7A illustrates examples of displays 702, 704 that can be provided by the feedback module 210 based on an output of the capture condition model 208. In this example, the capture condition model 208 has been trained to identify an orientation of a packaging face 706. The feedback includes a target box 708 representing a target positioning of the packaging face 706. The inclusion of a target box 708 (or other indicator of the target positioning) can aid in the capture of multi-pose test images, in which multiple test images are captured so that corrupted region(s) of the packaging face in any one of the images may be uncorrupted in other images, such that the entire packaging face can be analyzed in aggregate. For example, in some implementations the target box 708 is moved between different positions of the mobile device display 212 between capture of different images, to encourage moving the packaging and aid in capturing the packaging under a wider variety of conditions.

For detecting the orientation of the packaging face, the capture condition model 208 can be trained to determine whether the packaging face is tilted with respect to a target orientation and, in some implementations, a degree and/or characteristic of the tilt. For example, the target orientation can be a right-side-up orientation in which a top side of the packaging face faces a top of the image frame and a bottom side of the packaging face faces a bottom of the image frame (e.g., a roll angle of zero), a ninety-degree-rotated orientation in which the top side of the packaging face faces the right side or the left side of the imaging frame and the bottom side of the packaging face faces the left side or the right side, respectively, and/or an orientation in which the packaging face is imaged head-on (e.g., pitch and/or yaw angles of zero). In some implementations, the capture condition model 208 is trained to determine a quantity associated with the orientation, such as an angular degree of roll, pitch, and/or yaw. In some implementations, the capture condition model 208 is trained to classify the orientation, for example, into “correct orientation,” “tilt,” or “inverted,” where “correct orientation” can be, for example, a tilt within a predetermined difference from the target orientation, and where “inverted” can be an up-side down image or a left-right-inverted. “Tilt” can include a tilted orientation in one or more dimensions, e.g., pitch, yaw, and/or roll.

In the case of the display 702, the packaging face 706 is captured with a tilted orientation. In the case of the display 704, the packaging face 706 is captured with an inverted orientation. The displays 702, 704 can include one or more feedback elements to indicate the incorrect orientation to the user. For example, in some implementations the target box 708 can be displayed in a particular color to indicate the incorrect orientation (e.g., red), and/or a progress bar 710 can be made to not advance and/or be displayed in a particular color to indicate the incorrect orientation. Based on the feedback, the user can adjust the orientation. In some implementations, the capture condition model 208 is trained to determine whether the packaging face is in the target box 708, and the packaging face being substantially out of the target box 708 (e.g., a proportion of the packaging face out of the target box 708 being above a threshold) can correspond to an incorrect orientation.

FIG. 7B illustrates examples of displays 720, 722 that can be provided by the feedback module 210 in response to the capture condition model 208 indicating a correct orientation. In the displays 720, 722, the target boxes 724, 726 and the progress bars 728, 730 are changed to green (from red) to indicate the correct orientation. In addition, the progress bars 728, 730 progress from a first state in display 720 to a complete state in display 722, indicating progress in image capture based on the correct orientation. In this example, image capture results in capture of multiple multi-pose images: display 720 shows a single image 732, while display 722, corresponding to later in the image capture process, shows multiple images 734, one or more of which can be used for packaging authentication. As shown in FIG. 7B, target box 726 is in a different location from target box 724, so as to cause movement of the packaging face 706 and different capture conditions between the multiple images 734. The test image discussed with respect to process 100 can be an image captured without a multi-pose image process, a single one of multiple images in a multi-pose image process (such as a single one of the multiple images 734), or a composite image obtained by combining multiple images in a multi-pose image process, in various implementations.

In some implementations, the user interface guides the user to capture image(s) of packaging faces that need not be used for authentication, for example, side faces. Even if not used for authentication, these faces can be added to a database to aid in future forensics and analysis.

Referring again to FIG. 1, in response to output of the one or more machine learning models indicating that the one or more capture conditions are satisfied, and in response to the output of the one or more machine learning models indicating that the face of the first packaging is present in the image, the image is sent for authentication of the first packaging (108). For example, as shown in FIG. 2, the image suitability module 214 can receive outputs from the face identification model 206 and the capture condition model 208. For example, the output from the face identification model 206 can include an indication of whether a packaging face is present in the test image. In some implementations, the output from the face identification model 206 includes a face type of the packaging face present in the test image (e.g., front face or rear face). The output from the capture condition model 208 can include information relating to one or more capture conditions, e.g., a level of corruption in the test image, an orientation of the packaging face in the test image, whether any additional images need to be captured for a multi-pose image set, and/or other information.

Based on the outputs from the machine learning module 204, the image suitability module 214 can determine whether the conditions for authentication are satisfied, e.g., (i) whether a packaging face is present in the image and (ii) whether one or more capture conditions are satisfied. In some implementations, determining whether the conditions for authentication are satisfied includes comparing one or more of the outputs to a threshold level. For example, if the level of corruption (e.g., glare and/or shadow) in the image is above a threshold, the capture conditions can be determined to be not satisfied; otherwise, the capture conditions can be determined to be satisfied.

In some implementations, if one or more conditions are not satisfied, the image suitability module 214 can cause the feedback module 210 to output feedback to correct image capture and cause future images to satisfy the conditions. For example, the feedback can include a display stating “no packaging visible, please include packaging in the image,” “there is too much shadow, please increase lighting for image capture,” or “the packaging is currently in an inverted orientation, please face the packaging to the right instead of the left.”

If the one or more conditions are satisfied (e.g., as set forth for operation 108 in process 100), the image suitability module 214 can trigger the transmission module 216 to send the test image for authentication. For example, the transmission module 216 can include a network interface (e.g., an Internet interface), and the transmission module 216 can send the test image over the network interface to another computer system for authentication. In some implementations, the transmission module 216 sends the test image to a remote computer system, e.g., a cloud computer system. For example, the remote computer system can include elements of system 400 of FIG. 4. In some implementations, other information is sent in addition to the test image. For example, a face type of the packaging face in the test image (as output by the face identification model 206) can be sent by the transmission module 216, to aid in authentication.

FIG. 3 shows an example of an image authentication process 300. The process 300 can be performed by a computer system. For example, in some implementations the process 300 is performed by a computer system, such as a cloud computing system, that is remote from a mobile device that captured the test image discussed with respect to FIG. 1. The process 300 can be performed on a test image that was processed according to the process 100 and/or associated operations discussed herein.

FIG. 4 shows an example of a system 400 associated with process 300. For example, elements of the system 400 can be configured to perform process 300. For example, a reference image selection module 404, an image comparison module 406, and an optional symbol detection module 410 can be configured to perform the process 300 using a test image received from a mobile device 402. The modules 404, 406, 410 can be hardware and/or software modules, e.g., implemented by one or more computer systems. For example, the modules 404, 406, 410 can include one or more hardware processors and one or more computer-readable mediums encoding instructions that, when executed by the one or more hardware processors, cause the one or more hardware processors to perform operations such as portions of process 300 and/or other processes described herein. The modules 404, 406, 410 can be software modules executed by one or more hardware processors based on instructions encoded in one or more computer-readable mediums. In some implementations, the modules 404, 406, 410 are modules of a computing system such as a cloud computing system, such that process 300 and associated operations can be performed by a computer system with significant processing resources, so as to deliver authentication determinations rapidly to improve user experience. The modules 404, 406, 410 need not be separate but, rather, can be at least partially integrated together as one or more combined modules or fully integrated together as a single program.

The system 400 can include one or more computers 401 (e.g., a data processing apparatus) and a non-transitory computer-readable medium 403 tangibly encoding a computer program operable to cause the one or more computers 401 to perform process 100 and/or associated operations described herein. The one or more computers 201 and/or the non-transitory computer-readable medium 403 can implement at least some of the modules of FIG. 4.

The process 300 includes receiving an image from a mobile device (302). For example, the image can be the test image discussed with respect to FIGS. 1-2. In some implementations, based on the process 100, the test image is received with the presumption that the test image satisfies capture conditions and includes a packaging face, based on the processing performed by the machine learning module 204. In some implementations, a face type of the packaging face is received from the mobile device.

The process 300 further includes comparing the face of the packaging in the image to faces, in candidate images, having the same face type as the face in the image (304). As noted above, in some implementations the face type of the packaging in the test image is determined by the face identification model 206 and received from the mobile device 402. In some implementations, the face type is not received from the mobile device 402 but, rather, is determined by the system receiving the test image from the mobile device 402. For example, the system receiving the test image from the mobile device 402 can implement the face identification model 206 or another model trained to determine the face type.

The face type is used to reduce the search space for identifying a reference image for comparison. Because robust image-to-image comparisons to make a final authentication decision may be computationally intensive, it can be beneficial to perform such comparisons only on one or more specifically-identified reference images that are determined to be relevant to the test image, e.g., that are at least somewhat similar to the test image. The identification of one or more reference images can serve as a relatively fast, relatively computationally-efficient first-pass filter for ruling out packaging that is unlikely to match the packaging in the test image.

As shown in FIG. 4, the reference image selection module 404 includes (or accesses) a candidate image database 408. The candidate image database 408 includes records of authentic packaging for comparison. For example, in some implementations the candidate image database 408 includes, for each of a plurality of candidate packaging, one or more images corresponding to one or more faces of the candidate packaging. In some implementations, the candidate image database 408 includes, for each of a plurality of candidate packaging, a digital blueprint of the candidate packaging. The digital blueprint can be generated in a process such as process 500 described with respect to FIG. 5. For example, as further discussed in reference to FIG. 5, the digital blueprint for each candidate packaging can include, for each of one or more faces of the candidate packaging, (i) a label of the face type of the face, (ii) an image of the face, and (iii) text (if any) on the face.

The reference image selection module 404 is configured to compare feature(s) of the test image to corresponding feature(s) of faces of packaging depicted in candidate images in the candidate image database 408, in order to identify one or more reference images that satisfy a threshold level of similarity. In some implementations, the faces of the packaging to which the test image is compared have the same face type as the face in the test image. For example, if the test image depicts a rear face of packaging, then the reference image selection module 404 compares that rear face to rear faces of packaging in the candidate image database 408 (e.g., and not to front faces of packaging in the candidate image database 408). This ensures that only relevant packaging faces are used for comparison, providing significant improvement in comparison speed. For example, in a case where each packaging has two faces depicted in the candidate image database 408, this method can reduce the total search time (for identifying reference image(s)) by 50%, compared to performing comparisons for all faces.

The comparison between the test image and each candidate image can include (i) a textual comparison between text on the packaging face in the test image and text on the packaging face in the candidate image (e.g., as indicated by a digital blueprint having the text as a data element), (ii) a graphical comparison between the packaging face in the test image and the packaging face in the candidate image, or (iii) both (i) and (ii). The textual comparison can use any suitable text comparison algorithm, such as Jaccard similarity and/or cosine similarity, to provide a textual similarity. The graphical comparison can use any suitable graphical comparison algorithm, such as cosine similarity or Euclidean similarity, to provide a graphical similarity. In some implementations, this graphical comparison is performed using a simple/computational non-intensive graphical comparison algorithm, e.g., compared to an algorithm used to make a final authentication decision as described with respect to process 308 below. This can reduce the computational cost of identifying the reference image without compromising the final authentication decision.

Referring again to FIG. 3, the process 300 includes selecting a reference image from the candidate images based on the comparison (306). For example, the reference image selection module 404 can select one or more reference images, where the reference images are candidate images whose similarit(ies) with the test image satisfy a threshold condition, e.g., is above a threshold value. For example, in some implementations, the textual similarity and the graphical similarity are combined into a joint similarity, and the joint similarity is used to select the one or more reference images. In some implementations, the candidate image having the highest similarity is selected as the reference image.

In some implementations, the selection of a reference image may fail. For example, if the similarities with all searched candidate images are below a threshold value (e.g., the threshold value for selecting a reference image), then it can be determined that no reference image exists in the candidate image database 408. In some implementations, a notification can be provided to a user (e.g., a user of the mobile device 402) responsive to this determination. For example, in some implementations, an indication that the packaging in the test image is inauthentic is displayed (e.g., on the mobile device display 212), under the presumption that, if the packaging were authentic, a matching reference image would have been found. In some implementations, an indication that reference image selection has failed is displayed, e.g., because in some cases the lack of a reference image may be indicative of a missing entry in the candidate image database 408, rather than inauthentic packaging in the test image.

In some implementations, a data-encoding symbol can optionally be used to identify the reference image. The symbol detection module 410 can determine whether a data-encoding symbol is present in the test image and, if so, reference image identification is performed using the data-encoding symbol. The data-encoding symbol can include, for example, a barcode, a QR (quick response) code, or another one-dimensional or two-dimensional symbol that encodes data. The symbol detection module 410 can decode the symbol to obtain the encoded data, and can search for packaging having corresponding or matching data. For example, the encoded data can directly indicate a particular product, and, in response, an image of packaging of the particular product (from the candidate image database 408) can be selected as the reference image. This process can speed up selection of the reference image. However, a data-encoding symbol may not be available in all cases. In some implementations, if no data-encoding symbol is found or if the decoded data does not indicate a particular candidate image, another method, such as a textual and/or graphical comparison, can be used to identify the reference image.

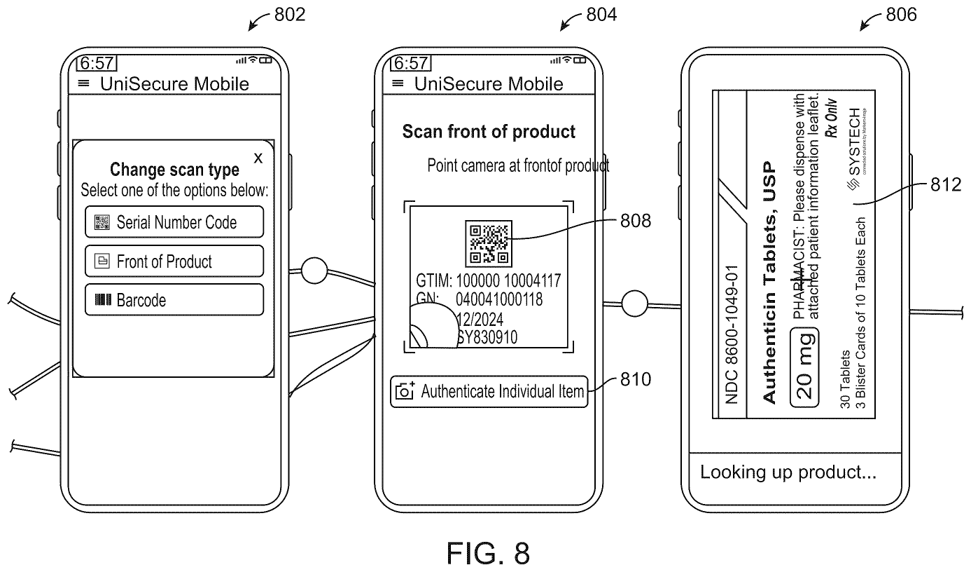

In some implementations, the mobile device 402 sends an indication of whether a data-encoding symbol is included in the test image, e.g., based on a selection by a user of the mobile device 402, as shown in FIG. 8.

If at least one reference image is identified, the image (e.g., the test image) is compared to the reference image to determine the authenticity of the packaging in the image (308). For example, as shown in FIG. 4, the reference image selection module 404 can provide the test image and the one or more reference images to the image comparison module 406. The image comparison module 406 is configured to determine a graphical similarity between the packaging face in the test image and the packaging face in each reference image. In some implementations, this graphical comparison uses a more computationally-intensive method than can be used by the reference image selection module 404, in order to provide more accurate comparison results. For example, the image comparison module 406 can determine one or more similarities using one or more of structural similarity index measure (SSIM), scale invariant feature transformation (SIFT), or Oriented FAST and Rotated BRIEF (ORB). Because the image comparison module 406 performs a relatively small number of comparisons (using the pre-selected reference images), the use of such methods will not consume excessive computational resources or take an excessively long time.

Based on the graphical similarity or similarities as determined by the image comparison module 406, the image comparison module 406 determines an authenticity of the packaging in the test image. For example, if a similarity between the test image and any of the reference images is above a threshold value, it can be determined that the packaging is authentic. In some implementations, the image comparison module 406 can classify the packaging into a category based on pre-defined similarity thresholds, e.g., “suspect/inauthentic,” “needs further review,” and “genuine,” each of those categories corresponding to an increasing similarity. In some implementations, if multiple reference images have been identified by the reference image selection module 404, the determination can be made based on the highest-similarity reference image (as determined by the image comparison module 406).

In some implementations, an output is provided to a user based on the determination by the image comparison module 406. For example, if the graphical similarity is above a threshold, the mobile device 402 can display a notification that “the product is authentic.” If the graphical similarity is below a threshold, the mobile device 402 can display a notification that “the product is inauthentic” or “the product may be inauthentic.” The notification can be displayed based on data sent from the image comparison module 406 to the mobile device 402, e.g., from the remote computing system performing process 300 to the mobile device 402 over one or more networks, such as the Internet.

In some implementations, in at least some cases in which the packaging in the test image is inauthentic, the image comparison module 406 can be configured to provide an identity of packaging/product of which the packaging in the test image is a counterfeit. For example, if the graphical similarity with a reference image (as determined by the image comparison module 406) is below a first threshold corresponding to authentic packaging but above a second threshold, it can be determined that the packaging in the test image is a counterfeit of the packaging in the reference image, because the two packaging are somewhat similar without being exact matches for one another. In some implementations, the identity of the packaging/product of which the packaging in the test image is a counterfeit is the identity of the packaging/product in the single identified reference image or the packaging/product in the reference image having the highest similarity from among multiple identified reference images.

In some implementations, prior to performing image comparison, the reference image selection module 404 aligns the test image with the reference image, e.g., causes the packaging face in the test image to have the same orientation as the packaging face in the reference image (e.g., by rotation of one or both images). This can ensure that comparisons are performed on aligned images to obtain accurate results.

In some implementations, comparison accuracy is aided by the use of multiple test images. For example, test images corresponding to two or more different face types can be used. The mobile device 402 can send a first test image showing a first face type (e.g., front face) and a second test image showing a second face type (e.g., rear face). The reference image selection module can select “reference packaging” based on one or both of the test images, where the candidate image database 408 stores multiple images of the reference packaging, respective ones of the multiple images depicting to the first face type and the second face type.

For example, the reference image selection module 404 can use the first test image to identify a first reference image that depicts a first face of particular packaging, the first face having the first face type (e.g., front face). The candidate image database 408, in addition to the first reference image, also includes a second reference image that shows a different face (e.g., rear face) of the same particular packaging, the different face having the second face type. Both of the reference images can be selected by the reference image selection module 404 and provided to the image comparison module 406. The image comparison module 406 can then graphically compare the first test image to the first reference image and the second test image to the second reference image to obtain two similarities, both of which can be used to determine an authenticity of the packaging in the test images. For example, the two similarities can be averaged or otherwise combined, and the combined similarity can be compared to a threshold value to determine the authenticity. As a result, authenticity determination can be performed more reliably, e.g., to identify counterfeits that may have one accurate face and one inaccurate face.

In some implementations, capture of multiple faces is used in response to an indeterminate authenticity determination, e.g., the “needs further review” determination discussed above. For example, in response to such a determination by the image comparison module 406 based on a first face of packaging, a user can be instructed (e.g., by instructions provided on the mobile device display 212 by the feedback module 210) to capture an image of a second face of the packaging. The image of the second face can then be processed to determine a graphical similarity between the image of the second face and a reference image of the second face. In some such cases, authenticity may be determined based on the second face even if the graphical similarity for the first face was such that authenticity could not be determined.

As another example of the use of multiple test images, the mobile device 402 can provide multiple test images to the reference image selection module 404, the multiple test images depicting the same packaging face but with different packaging positionings, capture conditions, etc. For example, the multiple test images can be images of a multi-pose set captured as described with respect to FIGS. 1-2. Each of the multiple test images can then be graphically compared to the reference image by the image comparison module 406, and a mean similarity (or other aggregate/joint similarity) can be used to determine the authenticity of the packaging in the test image. By using multiple images of the same face, the net effect of environmental noise such as glare, shadow, mechanical/surface scratches on the packaging, and/or other forms of minor degradation can be reduced.

In some implementations, both multi-face-type comparisons and multi-pose set comparisons are performed, and the various similarities that result are combined into an aggregate similarity measure that the image comparison module 406 uses to assess the authenticity of the packaging in the test images.

FIG. 8 illustrates examples of user interfaces 802, 804, 806 that can be displayed during performance of the processes 100, 300. The user interfaces 802, 804, 806 can be displayed, for example, on the mobile device display 212, e.g., of the mobile device 402. User interface 802 provides controls allowing a user to select between scanning a serial number code (e.g., a QR code), capturing a test image of a front of packaging, or scanning a barcode (e.g., a one-dimensional barcode). User interface 804 shows a live image of capture by the mobile device camera 202, in this case for scanning a QR code 808. An interface element 810 triggers the sending of the QR code 808 (or data encoded by the QR code 808), along with a test image 812 of packaging, for authentication. User interface 806 can be displayed while a remote system performs authentication, e.g., performs process 300. The remote system uses the QR code 808 to identify one or more reference images, as discussed with respect to the symbol detection module 410. At the conclusion of authentication, another user interface (not shown) can display an authentication result.

FIG. 5 illustrates a process 500 for (i) generating digital blueprints for comparison to identify reference images and perform packaging authentication, and (ii) training machine learning models described herein, such as the face identification model 206 and the capture condition model 208. The process 500 can be performed, for example, by a mobile device or local computer system, by a remote computer system such as a cloud computer system, or by both, as discussed in further detail below. For example, image capture and/or upload, and manual annotation, can be performed using a mobile device or local computer system, while auto-annotation, model training, and/or digital blueprint generation can be performed using a remote computer system.

The process 500 includes obtaining an image of packaging (502). While processes 100 and 300 related to testing the authenticity of packaging, the packaging discussed with respect to FIG. 5 is known to be authentic. Accordingly, information about the packaging can be added to the candidate image database 408 for use in subsequent authentications. Obtaining the image of the packaging can include, for example, obtaining an uploaded image of the packaging or capturing an image of the packaging. The image can be captured, for example, by a camera of a mobile device.

The image is processed using a machine learning model (sometimes referred to as an “auto-annotation machine learning model”) trained to determine a face type of a face of the packaging (504). For example, the auto-annotation machine learning model can be trained to identify whether the image portrays a front face or a rear face of the packaging. In some implementations, the auto-annotation machine learning model has been trained to extract text from the packaging in the image for auto-annotation purposes. In some implementations, the auto-annotation machine learning model is an object detection model trained on a set of packaging images to delineate and identify different faces such as front and rear faces, the packaging images labeled with (i) locations of the packaging faces in the images and (ii) an indicator of face type for each packaging face. The auto-annotation machine learning model can output an auto-annotation that includes a face type of the packaging face in the image, a location of the packaging face in the image, and/or text included in the packaging face in the image.

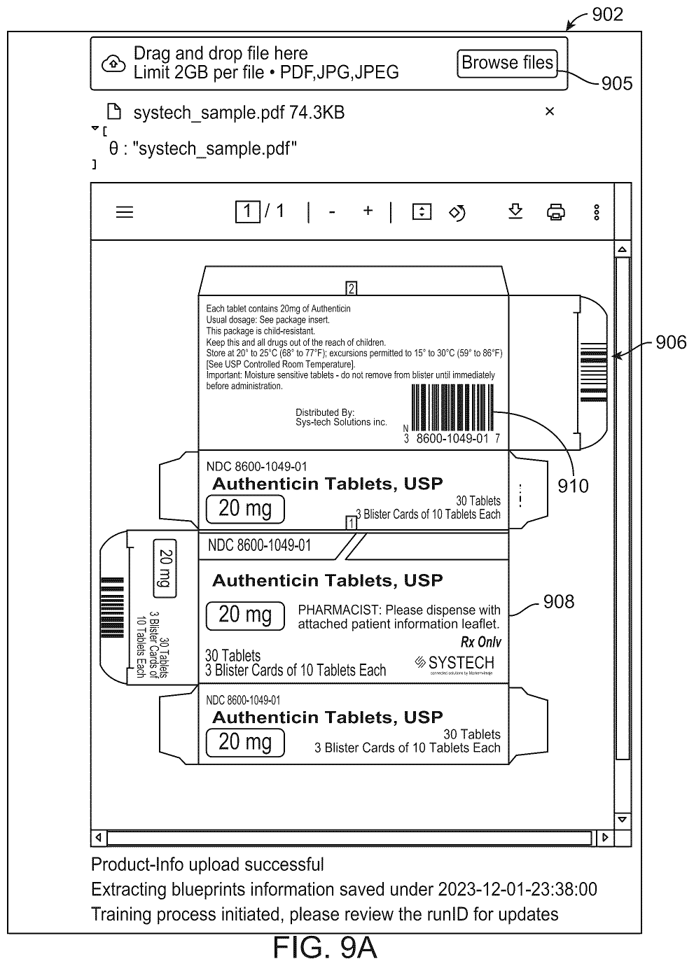

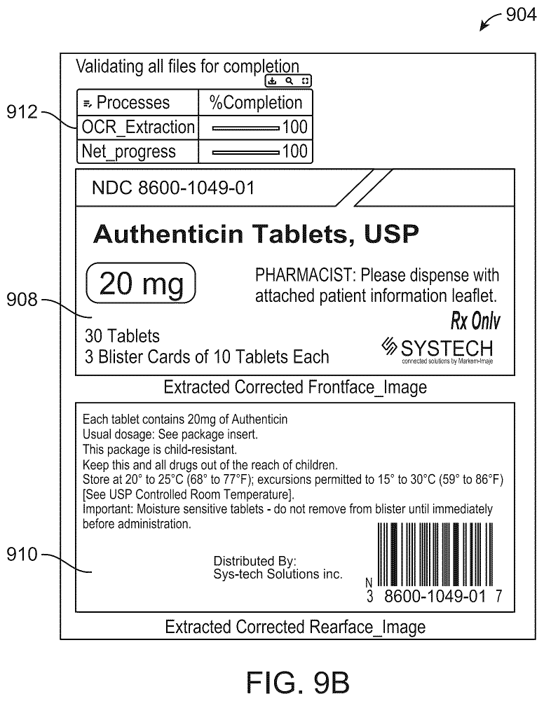

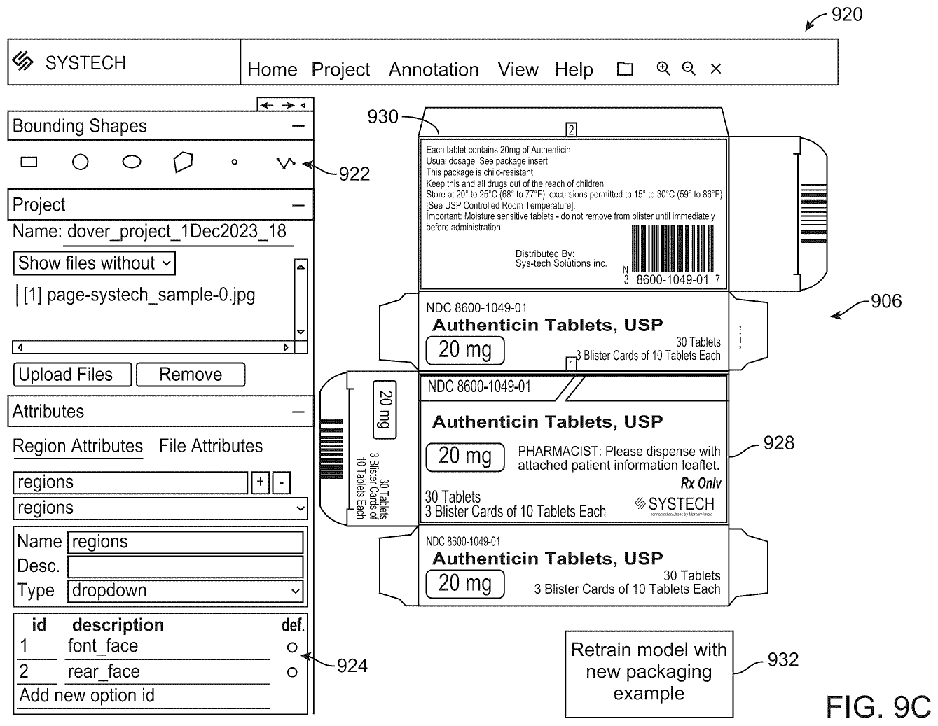

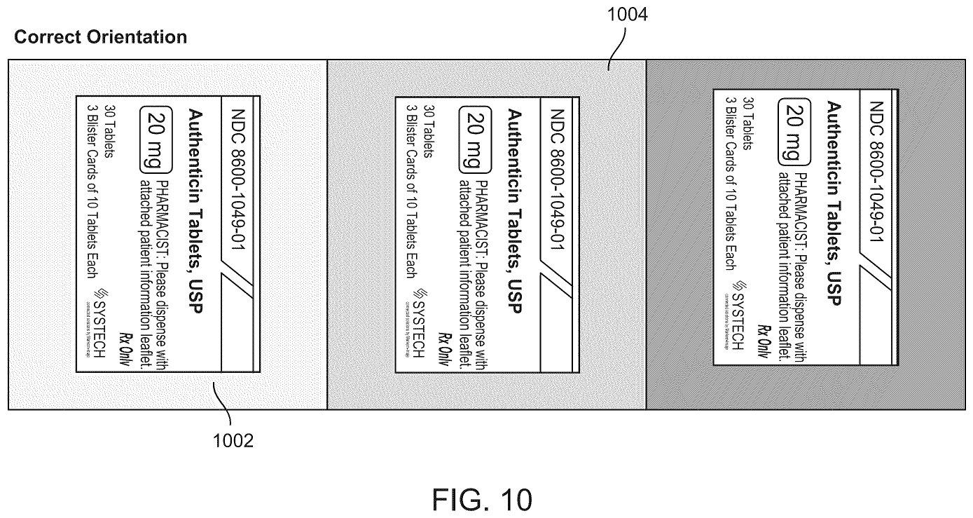

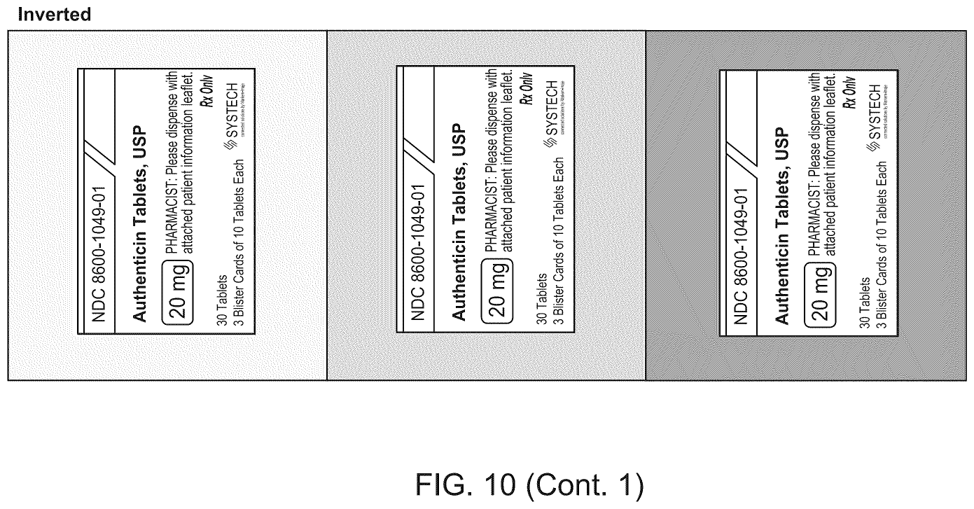

In some implementations, the obtained image (502) portrays multiple packaging faces, e.g., when the image is an uploaded image that includes an “unfolded” packaging, for example, as shown in FIG. 9A. As such, processing by the auto-annotation machine learning model can include the identification of multiple faces, determination of the face types of the multiple faces, and auto-annotation of the multiple faces.

The auto-annotation machine learning model used in operation 504 of the process 500 can be different from the machine learning model(s) of the machine learning module 204. For example, in some implementations, the machine learning module 204 is a module of a mobile device, while the auto-annotation machine learning model is implemented in a module of a remote computer system. For example, after capture or upload of the image at a mobile device (502), the mobile device can send the image to the remote computer system for further processing (e.g., auto-annotation), including processing by the auto-annotation machine learning model (504).

FIGS. 9A-9C illustrate examples of user interfaces 902, 904, 920 associated with the process 500, e.g., that can be displayed to a user of a mobile device or other computing device during performance of the process 500. As shown in FIG. 9A, user interface 902 includes an element 905 used to select an image of product packaging (502). In this example, a PDF file containing an image 906 is selected. The image 906 includes multiple packaging faces, such as a front face 908 and a rear face 910. The image 906 can be sent from the mobile device or other computing device to a remote system for processing, e.g., for auto-annotation (504)

User interface 904 illustrates at least partial results of auto-annotation. The auto-annotation machine learning model has identified and extracted images of each of the front face 908 and the rear face 910. In addition, the auto-annotation model has performed text recognition and extraction on the faces 908, 910, as indicated by an “OCR_Extraction” progress bar 912 that refers to optical character recognition (OCR).

Referring again to FIG. 5, in some implementations, a user of the mobile device (e.g., the mobile device that provides the image in operation 502) is provided with an interface usable to manually alter the auto-annotation and/or to manually annotate (506), e.g., to correct any errors in the auto-annotation. The manual annotation can include identification of packaging faces and face types, entry of text on the packaging faces, selection of locations of the packaging faces, and/or other annotation operations. For example, FIG. 9C illustrates a user interface 920 for manual annotation. User interface 920 includes, among other features, the uploaded/captured image 906, a selection of bounding shapes 922 selectable by a user to bound packaging faces in the image 906, and an attributes menu 924 usable to label face(s) portrayed in the image 906, e.g., to label with a face type and/or with text included on the face. In this case, auto-annotated bounding boxes 928, 930 bound the front and rear faces 908, 910. The user can adjust the bounding boxes 928, 930 if the auto-annotation machine learning model has incorrectly identified the bounds of the faces 908, 910.

As a result of machine learning-based auto-annotation (504) with optional manual annotation (506), a digital blueprint is generated (508). The digital blueprint represents attributes of the packaging for subsequent comparison during authentication testing, e.g., during process 300. For example, the digital blueprint can be included in the candidate image database 408 for use in selecting a reference image.

An example of a digital blueprint 512 is shown in FIG. 5. The digital blueprint 512 is a data object representing attributes of one or more faces of the packaging. In this example the digital blueprint 512 includes, for two faces of the packaging, an indicator of the face type (“front face” or “rear_face”), an image of the face (e.g., based on auto-annotated and/or manually annotated bounding boxes, in this case saved in .jpg form), and text included on the face (in the example of FIG. 5, a table cell that includes text of the front face has been selected and so obscures text extracted from the rear face). The digital blueprint 512 can be used, for example, to determine a textual similarity and/or a graphical similarity during reference image selection, and/or to determine a graphical similarity during final packaging authentication.

In some implementations, the image of each face (e.g., in the digital blueprint 512) is rotated (if necessary) to be in a particular orientation, e.g., corresponding to a “correct” orientation.

In some implementations, the packaging annotations are used for machine learning model training. This can allow users without technical machine learning experience to train authentication models (such as the face identification model 206, the capture condition model 208, and/or the auto-annotation machine learning model itself) through user interfaces, e.g., without having to perform coding or other technical tasks.

In some implementations, model training is performed based on an augmented dataset of packaging images. For example, as shown in FIG. 5, the process 500 can include generating further images differing in one or more parameters (510). The further images can be based on image(s) extracted in the auto- and/or manual annotation 504, 506, and the parameters can include one or more of background, orientation, image contrast, and/or corruption. The backgrounds can include backgrounds of various colors, textures, and/or images, e.g., to emulate typical environments in which users are likely to capture test images (e.g., a factory floor).

Because the further images are generated, each further image has known ground-truth label(s) (e.g., labeling the orientation of the packaging face, the location of the packaging face in the image, corruption in the image, etc.), and the labeled images can be used as training data for one or more of the machine learning models described herein.

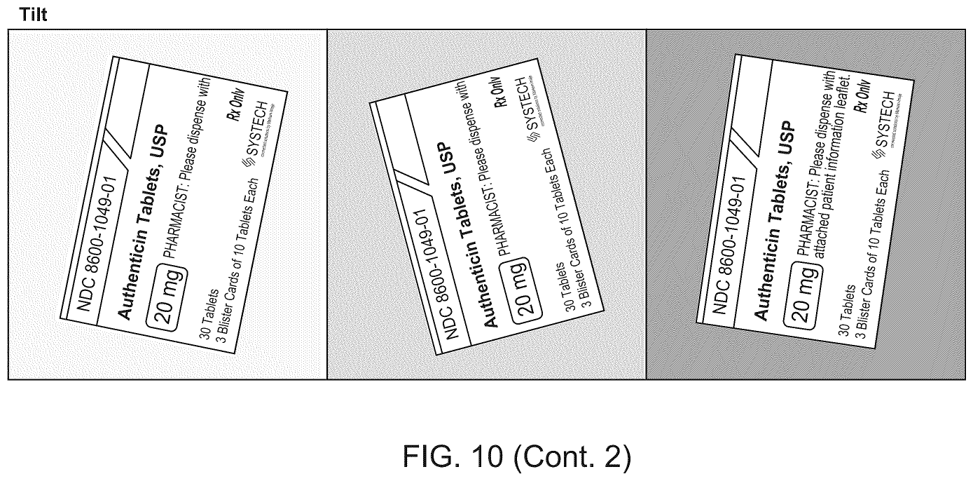

For example, FIG. 10 illustrates examples of images generated based on the extracted front face 908 of the packaging shown in FIGS. 9A-9C. The images differ from one another in background (e.g., backgrounds 1002, 1004) and orientation (e.g., labeled with “correct,” “inverted,” and “tilt[ed].” Implicit in FIG. 10 is that each image is also labeled with a location of the packaging face in the image. Moreover, in some implementations each image is labeled with the face type of the face, known based on the prior annotation. Not shown in FIG. 10, but within the scope of this disclosure, is the addition of simulated/generated corruption, such as shadow and/or glare, in the generated images.

Accordingly, using the generated images and their labels as training data, an object detection model (such as the face identification model 206, the capture condition model 208, and/or the auto-annotation machine learning model) can be trained (514) to identify packaging faces in images (including determining the locations of the packaging faces), determine the face types of the faces, and/or determine capture condition information such as orientation and glare level/location. This training can be performed without requiring arduous capture of many images of the packaging from many different orientations and in different capture conditions. Rather, in some implementations, a single image of a face of packaging can be used to generate many training images, improving model accuracy and reliability while improving the user experience. Model training or re-training can be performed easily through a graphical user interface, such as the interfaces 902, 904, 920 of FIGS. 9A-9C. For example, a user can select button 932 in FIG. 9C to trigger (i) generation of additional images based on the annotations of FIG. 9C and (ii) training based on the additional images, so that the machine learning model(s) will be retrained with a new example of packaging. This user-friendly approach to annotation and model training can make it more likely for users to participate (e.g., to upload packaging), increasing the dataset available for training and improving model accuracy and/or reliability.

Types of machine learning models within the scope of this disclosure include, for example, machine learning models that implement supervised, semi-supervised, unsupervised and/or reinforcement learning; neural networks, including deep neural networks, autoencoders, convolution neural networks, multi-layer perceptron networks, and recurrent neural networks; classification models; and regression models. The machine learning models described herein can be configured with one or more approaches, such as back-propagation, gradient boosted trees, decision trees, support vector machines, reinforcement learning, partially observable Markov decision processes (POMDP), and/or table-based approximation, to provide several non-limiting examples. Based on the type of machine learning model, the training can include adjustment of one or more parameters. For example, in the case of a regression-based model, the training can include adjusting one or more coefficients of the regression so as to minimize a loss function such as a least-squares loss function. In the case of a neural network, the training can include adjusting weights, biases, number of epochs, batch size, number of layers, and/or number of nodes in each layer of the neural network, so as to minimize a loss function. Because each machine learning model is defined by its parameters (e.g., coefficients, weights, layer count, etc.), and because the parameters are based on the training data used to train the model, machine learning models trained based on different data differ from one another structurally and provide different outputs.

In some implementations, the face identification model 206 is additionally trained using images of inauthentic packaging and/or images without packaging. The use of this training data can improve the ability of the face identification model 206 to determine whether a packaging face is present in test images. For example, images of counterfeit packaging can be uploaded and annotated in a manner similar to the process 500, with suitable modifications to ensure that the images of counterfeit packaging are not treated as authentic.

Images processed according to the methods described herein (e.g., test images and images uploaded/captured to model training and digital blueprint generation) can be collected and labeled for various analyses. For example, images of packaging can be labeled with location to allow for location-aware authentication testing. For example, if tested packaging in a first country matches authentic packaging that is only used in a second country, the tested packaging may be determined to be inauthentic, or the tested packaging can be marked for further investigation. As another example, images of packaging can be labeled with timestamps to facilitate user-friendly tracking of changes in packaging over time, e.g., to view product relaunches over time.

Accordingly, based on the foregoing systems and processes, machine learning models can be trained on auto-annotated images of packaging, speeding up data intake and improving user experience. Manual annotation can be used to supplement the auto-annotation to improve the accuracy of training data and improve the outputs of trained machine learning models. Generation of multiple images of packaging with different characteristics can provide expanded sets of training data to improve machine learning model accuracy and/or reliability. The use of training data labeled with a face type results in machine learning models that differ from other machine learning models, allowing the machine learning models to detect face types in test images and/or for auto-annotation. The use of face type as a model output allows packaging faces having matching faces to be compared to one another, significantly reducing the search space for packaging authentication and reducing the computational resources used for authentication. The addition of a reference image selection process prior to final image authentication can also improve the efficiency of authentication.

Some features described herein, such as the systems 200, 400 and elements thereof, may be implemented in digital and/or analog electronic circuitry or in computer hardware, firmware, software, or in combinations of them. Some features may be implemented in a computer program product tangibly embodied in an information carrier, e.g., in a machine-readable storage device, for execution by a programmable processor. Method steps may be performed by a programmable processor executing a program of instructions to perform functions of the described implementations by operating on input data and generating output, by discrete circuitry performing analog and/or digital circuit operations, or by a combination thereof.

Some described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java, Python, JavaScript, Swift), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random-access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits). To provide for interaction with a user the features may be implemented on a computer having a display device such as a CRT (cathode ray tube), LED (light emitting diode) or LCD (liquid crystal display) display or monitor for displaying information to the author, a keyboard and a pointing device, such as a mouse or a trackball by which the author may provide input to the computer.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method, comprising:
capturing, at a mobile device, an image using a camera of the mobile device;
processing, at the mobile device, the image using one or more machine learning models, wherein the one or more machine learning models have been trained to
identify a face of first packaging in the image, and
determine whether the first packaging in the image satisfies one or more capture conditions;
providing, at the mobile device, feedback for image capture based on a first output of the one or more machine learning models relating to the one or more capture conditions; and
in response to output of the one or more machine learning models indicating that the one or more capture conditions are satisfied, and in response to the output of the one or more machine learning models indicating that the face of the first packaging is present in the image, sending the image for authentication of the first packaging.

2. The method of claim 1, wherein the one or more machine learning models have been trained to determine a face type of the face of the first packaging.

3. The method of claim 2, wherein the face type comprises a front face or a rear face.

4. The method of claim 2, comprising determining whether the first packaging is authentic, wherein determining whether the first packaging is authentic comprises:
selecting, from two or more faces of second packaging, a first face based on the face type of the face of the first packaging matching a face type of the first face of the second packaging;
determining at least one similarity between the first face and the face of the first packaging; and
selecting, from among a plurality of images of packaging, an image of the second packaging as a reference image based on the at least one similarity between the first face and the face of the first packaging.

5. The method of claim 4, wherein the at least one similarity comprises:
a textual similarity between text included on the face of the first packaging and text included on the first face of the second packaging, and
a graphical similarity between the reference image and the image.

6. The method of claim 4, wherein determining whether the first packaging is authentic comprises:
in response to selecting the image of the second packaging as the reference image, determining whether the first packaging is authentic based on a comparison between the first packaging in the image and the second packaging in the reference image.

7. The method of claim 1, comprising determining whether the first packaging is authentic, wherein determining whether the first packaging is authentic comprises:
determining whether the image includes a data-encoding symbol;
in response to determining that the image includes the data-encoding symbol,
decoding data encoded by the data-encoding symbol, and
determining a reference image based on the data, or
in response to determining that the image does not include the data-encoding symbol, determining the reference image based on a graphical comparison between the image and the reference image.

8. The method of claim 1, comprising determining whether the first packaging is authentic, wherein determining whether the first packaging is authentic comprises:
receiving the image from the mobile device, and
processing the image using a machine learning model distinct from a first machine learning model, of the one or more machine learning models, that has been trained to identify the face of the first packaging in the image.

9. The method of claim 1, comprising determining whether the first packaging is authentic, wherein determining whether the first packaging is authentic comprises:
determining a textual similarity between text in the image and text in a reference image;
determining a graphical similarity between the image and the reference image;
determining, based on at least one of the textual similarity or the graphical similarity, that the first packaging is not authentic; and
determining, based on the image, a packaging of which the first packaging is a counterfeit.

10. The method of claim 1, wherein the one or more capture conditions are based on at least one of an orientation of the first packaging in the image or a level of corruption in the image.

11. The method of claim 1, wherein the feedback for image capture comprises at least one of:
a graphical bound for placement of the first packaging during image capture, the graphical bound being moved to different locations on a display of the mobile device over capture of multiple images,
an indication of whether an orientation of the first packaging satisfies an orientation condition, or
a progress indicator that progresses based on satisfaction of the one or more capture conditions.

12. The method of claim 1, wherein the feedback for image capture comprises an indicator of a location of corruption in the image.

13. The method of claim 1, comprising training the one or more machine learning models, wherein training the one or more machine learning models comprises:
obtaining an image of reference packaging;
generating a plurality of images by modifying at least one of orientation, background, or contrast of the image of the reference packaging; and
training the one or more machine learning models using the plurality of images as training data.

14. The method of claim 1, comprising determining whether the first packaging is authentic, wherein determining whether the first packaging is authentic comprises:
comparing at least one feature of the first packaging to a digital blueprint of reference packaging, the digital blueprint comprising:
a label indicating a face type of a face of the reference packaging,
a graphical representation of the face of the reference packaging, and
text included on the face of the reference packaging.

15. The method of claim 14, comprising generating the digital blueprint, wherein generating the digital blueprint comprises:
processing an image of the reference packaging using a machine learning model that has been trained to determine the face type of the face of the reference packaging; and
generating the digital blueprint based on an output of the machine learning model that has been trained to determine the face type of the face of the reference packaging.

16. The method of claim 1, comprising training the one or more machine learning models using
as training data, images of faces of a plurality of packaging, and
as labels for the training data, data indicative of types of faces of the plurality of packaging portrayed in the images.

17. The method of claim 1, wherein the one or more machine learning models comprise a first machine learning model that has been trained to identify the face of the first packaging in the image, and a second machine learning model that has been trained to determine whether the first packaging in the image satisfies the one or more capture conditions.

18. The method of claim 1, comprising training the one or more machine learning models, wherein training the one or more machine learning models comprises:
providing, in a user interface, a display of an image of reference packaging captured by a second mobile device;
processing the image of the reference packaging using a machine learning model that has been trained to identify a face of the reference packaging in the image of the reference packaging, to obtain, as an output, an auto-annotation indicative of at least one of
text included in the face of the reference packaging, or
a face type of the face of the reference packaging;
providing, in the user interface, one or more tools usable to manually alter the auto-annotation to obtain a modified annotation; and
training the one or more machine learning models using, as training data, the image of the reference packaging and the modified annotation.

19. A non-transitory computer-readable medium tangibly encoding a computer program operable to cause a data processing apparatus to perform operations comprising:
capturing, at a mobile device, an image using a camera of the mobile device;
processing, at the mobile device, the image using one or more machine learning models, wherein the one or more machine learning models have been trained to identify a face of first packaging in the image, and
determine whether the first packaging in the image satisfies one or more capture conditions;
providing, at the mobile device, feedback for image capture based on a first output of the one or more machine learning models relating to the one or more capture conditions; and
in response to output of the one or more machine learning models indicating that the one or more capture conditions are satisfied, and in response to the output of the one or more machine learning models indicating that the face of the first packaging is present in the image, sending the image for authentication of the first packaging.

20. A system comprising:
one or more computers programmed to authenticate packaging; and
a mobile device communicatively coupled with the one or more computers, the mobile device being programmed to perform operations comprising:
capturing, at a mobile device, an image using a camera of the mobile device;
processing, at the mobile device, the image using one or more machine learning models, wherein the one or more machine learning models have been trained to identify a face of first packaging in the image, and
determine whether the first packaging in the image satisfies one or more capture conditions;
providing, at the mobile device, feedback for image capture based on a first output of the one or more machine learning models relating to the one or more capture conditions; and
in response to output of the one or more machine learning models indicating that the one or more capture conditions are satisfied, and in response to the output of the one or more machine learning models indicating that the face of the first packaging is present in the image, sending the image to the one or more computers for authentication of the first packaging
